(19) United States
(12) Patent Application Publication
(10) Pub. No.: US 2010/0217866 A1
(43) Pub. Date: Aug. 26, 2010

(54) Load Balancing in a Multiple Server System Hosting an Array of Services

(76) Inventors: Thyagarajan Nandagopal, Edison, NJ (US); Thomas Y. Woo, Short Hills, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/391,724

(22) Filed: Feb. 24, 2009

(51) Int. Cl. G06F 15/173

(52) U.S. Cl. 709/226

(57) ABSTRACT

A method and system for load balancing in a multiple server system supporting multiple services are provided to determine the best server or servers supporting a service with the best response time. An induced aggregate load is determined for each of the multiple services in accordance with corresponding load metrics. A maximum induced aggregate load on a corresponding server that generates a substantially similar QoS for each of the plurality of services is determined. A load balancing server distributes the multiple services across the multiple servers in response to the determined induced aggregate and maximum induced aggregate loads, such that the QoS for each of the multiple services is substantially uniform across the servers.

### FIELD OF THE INVENTION

The invention relates to load balancing in general and in particular to load balancing in a multiple server system yielding uniform response time for a particular service regardless of the server performing the service.

### BACKGROUND

Conventional load balancing systems are tailored for a single service provider. However, in emerging multi-server systems that are located in massive data centers operated by a network provider, server resource is a commodity that can be bought, leased or rented by any service provider. While current load balancing systems achieve load balancing at the level of a service, different services would most likely run at different load levels. A multi-server environment would require a load balancing system capable of balancing the traffic destined to each service between the servers hosting the service. For example, it may be desirable to run web proxy, WAN acceleration, anti-virus scanning, IDS/IPS tools and firewalls within the data center. However, the data center may not have dedicated computing resources to exclusively support the maximum load for each of these services.

### BRIEF SUMMARY OF THE INVENTION

Various deficiencies of the prior art are addressed by the present embodiments including a method and system provide for load balancing in a multi-server environment hosting multiple services. Specifically, the method according to one embodiment comprises: determining, an induced aggregate load for each of the multiple services in accordance with corresponding load metrics; determining, the maximum induced aggregate load on a corresponding server to generate a substantially similar QoS for each of the plurality of services; and distributing, the multiple services across the multiple servers in response to the determined induced aggregate and maximum induced aggregate loads, wherein the QoS for each of the multiple services is substantially uniform across the servers.

In another embodiment, a method comprises the steps of: determining, the QoS for each of the multiple services running on a corresponding server; and transmitting, a new request for service to the server with the best QoS for the corresponding service.

In yet another embodiment in a system having at least one load balancing server communicatively coupled to at least one server supporting multiple services, each load balancing server is adapted to distribute the multiple services wherein the QoS for each of the multiple services is substantially uniform across one or more servers supporting a corresponding service. One or more networked servers are adapted to compute the respective induced aggregate load and the maximum induced aggregate load for each of multiple services supported by the servers.

### BRIEF DESCRIPTION OF THE DRAWINGS

The teachings of the present embodiments can be readily understood by considering the following detailed description in conjunction with the accompanying drawings, in which:

FIG. 1 depicts a block diagram of a load balancing system in a multiple server network supporting multiple services according to one embodiment;

FIG. 2 graphically depicts the distribution of services in a four-server system load balancing according to one embodiment; and

FIG. 3 graphically depicts the distribution of services yielding uniform response time across multiple servers in a four-server system according to one embodiment.

To facilitate understanding, identical reference numerals have been used, where possible, to designate identical elements that are common to the figures.

### DETAILED DESCRIPTION OF THE INVENTION

The next generation of hosted environments is modeled on the premise that a particular server can run more than one service, for example, as one virtual machine per service on a physical server. Therefore, it is desirable to support more services using the same set of servers, since it is unlikely that these services will all be overloading the servers at the same time. Paradoxically, the response time for each service is dependent on the load of the server.

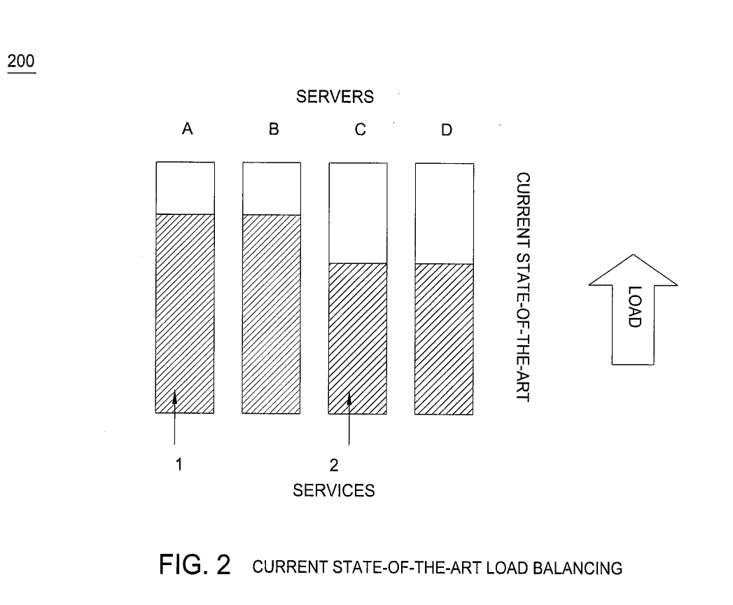

FIG. 2 graphically depicts the distribution of services in a four-server system load balancing according to one embodiment. Specifically, FIG. 2 shows that multiple servers are needed, if one service needs more than one fully dedicated server to handle its load (even if the load is 101% of single server capacity). Therefore, in a system of four (4) servers, one can support at most two (2) such services using current load-balancing systems. While load-balancing is achieved at the level of a service, different services are running at different load levels as depicted. However, it is desirable to support more services using the same set of servers. Since it is unlikely that these services will all be overloading the servers at the same time, it is efficient to thereby employ the multiplexing effect that can be achieved. Paradoxically, the response time for each service is dependent on the load of the server. Therefore, for a given service, it is desirable to ensure that all servers hosting this service instance experience the same load, thereby providing the same response time from all servers supporting this service. This is the goal achieved by the present embodiments. Furthermore, the embodiments allow for overlapping services on a single server.

Since current systems apply their load balancing metric to only one service, the above condition cannot be satisfied using the current state-of-the-art. The present embodiments depart from the conventional paradigm and provide for a single server supporting multiple services, while simultaneously applying load balancing concepts on the aggregated services across multiple servers.

The distribution of the services can be effected such that all servers running this service instance experience the same load. This mechanism exploits the multiplexing effect that can be achieved. The foregoing articulated objective is not satisfied using the current state-of-the-art load balancing, because current systems apply their load balancing metric to only one service. Therefore, what is needed is a system that is adapted to run multiple services on a single server, yet allowing the load balancing concepts to be applied on the aggregated services across multiple servers.

The present embodiments are primarily described within the context of load balancing in a multiple server system supporting multiple services; however, those skilled in the art and informed by the teachings herein will realize that the invention is also applicable to other technical areas and/or embodiments.

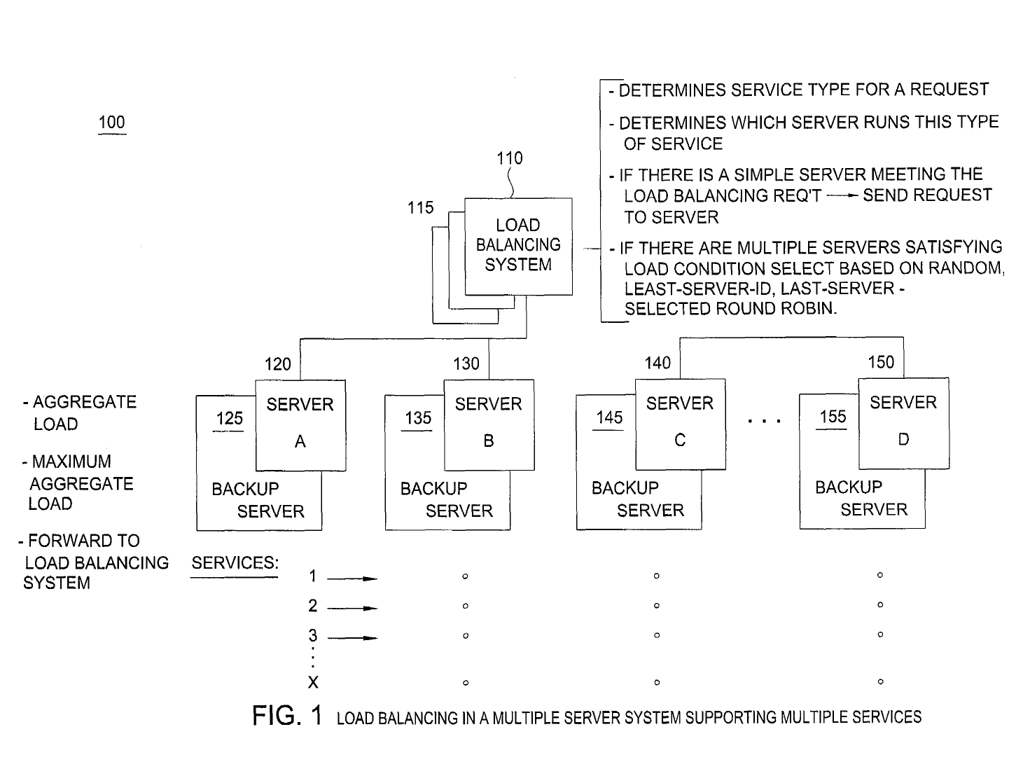

FIG. 1 depicts a block diagram of a load balancing system in a multiple server network supporting multiple services according to one embodiment. Specifically, load balancing system 100 is adapted to support multiple services with substantially similar QoS for each of the plurality of services. A load balancing server 110 is communicatively coupled to at least one server 120 or more servers 130-150. The load balancing server is linked to servers 120-150 using an appropriate network topology. In one embodiment, the load balancing system comprises one server. However, in other embodiments, the load balancing system comprises more than one server such as denoted by 115. The architecture of the load balancing system provides dual-redundancy in that each server 120-150 is equipped with a backup 125-155 allowing for seamless server failover.

One embodiment allows for overlapping services on a single server. Other embodiments provide an array of servers wherein each server is adapted to host different sets of services such that the response times for a service is independent of the server supporting the particular service. In addition, overlapping services on a single server facilitates the use of the multiplexing benefits to support a large number of services on relatively a few servers. This translates to capital (capex) and operational expenditures (opex) savings in the form of reduced infrastructure, lower management costs, less power consumption, etc.

Existing solutions require that a server exclusively supports only a single service. A load balancer that balances among multiple servers essentially interfaces to only a disjointed set of servers for each service. Existing solutions are ill suited to implement the multiple services on a single server model, while load balance them effectively and contemporaneously providing improved Quality of Service (QoS).

The embodiments herein disclosed depart from the traditional QoS paradigm. Traditionally, QoS refers to the capability of a network to provide better service to selected network traffic over various technologies including Ethernet, Frame Relay, Asynchronous Transfer Mode (ATM) etc. The primary goal of QoS is to provide priority including dedicated bandwidth, controlled jitter, latency and improved loss characteristics. Fundamentally, QoS enables a system to provide better service to certain flows.

The load induced on a server or exerted by a certain service can be measured in the form of active connections, central processing unit (CPU) load, memory consumption, free memory, input/output (I/O) bandwidth consumption, network throughput, or any combination thereof. Each of the above metrics can either be expressed as an absolute number or as a percentage of the maximum possible value. It will be understood by an artisan of ordinary skill in the art that the present embodiments are not limited to these load metrics, but that other load metrics can be considered, e.g., geographic location, queue overflow, congestion, traffic shaping and policing.

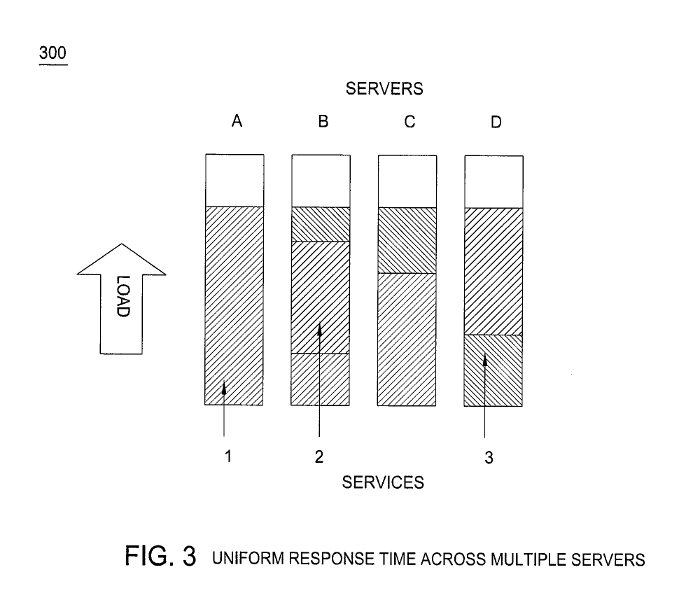

The present embodiments provide at least the following advantages over the prior art. FIG. 3 graphically depicts the distribution of services yielding uniform response time across multiple servers in a four-server system according to one embodiment. Specifically, as depicted in FIG. 3, the response time for a particular service is uniform across all servers supporting or hosting the service. A single server can support multiple services. Different servers can host a different mix of services. Each service can be configured to only run on a select subset of servers within a plurality of servers and still obtain substantially the same response time. These advantages are subject to the following constraints: (1) the services running on a single server are assumed to use the same load metric; (2) the response time for a service, s_i, is a function of the load on the server, and this function f_i( ) is non-decreasing and monotonic e.g., f_i( )=x²; (3) different services can have varying response time functions; and (4) there exists a load balancing algorithm ‘X’ which, when applied to multiple servers hosting only a single service, can provide uniform response times for this service. This essentially implies that one of the current load-balancing algorithms that can provide load balancing for a single service is utilized.

The load metric of a server is sent to the load balancing system. In addition, the f_i( ) for service s_i is available at all servers running this service. If f_i( ) is not available at the load-balancing system, an alternative solution is hereafter articulated.

As expressed above, the load balancer needs to be able to balance the traffic, while ensuring that the load on the servers is nearly the same. To illustrate this concept, consider a set of n services S={s_i}, i=1, 2, . . . , n. Let there be m servers, numbered from 1 to m. Let each service s_i run on a set of servers P_iε{1,2, . . . ,m}. Let the load on server j due to service i be denoted by l(i,j). Current load balancing systems ensure that l(i,j)=l(i,k), for all j,kεP_i. However, this is useful only if each server runs at most one service, where

$${\sum }_{i = 1}^{n} l ( i , j ) = l ( {i}^{′} , j )$$

if jεP_i′. The next generation of hosted environments is modeled on the premise that a particular server can run more than one service (for example, as one virtual machine per service on a physical server). This implies that

$${\sum }_{i = 1}^{n} l ( i , j ) = {\sum }_{i = 1}^{n} l ( i , k )$$

for all j,kεP for any service s_iεS. In other words, for any particular service running in the multi-server environment, considering the servers running the particular service, the aggregate load on these servers from all the services that they are supporting should be the same.

In one embodiment, the response times are extrinsic to the load balancer. In another embodiment, the response times are intrinsic to the load balancer. In the extrinsic case, the load balancing system extrapolates the distribution function for each service based on two main components: (A) at the individual servers; and (B) at the load balancing system.

### A. At the Individual Servers.

Given a load metric, the induced load is computed for each service s_i on each server j, and is denoted as l(i,j). The response time for service s_i running on server j is denoted by r(i,j). The goal is to ensure that r(i,j)=r(i,k)=R(i), for all j,kεP_i, and this relationship to also hold true for all s_iεS. Note that R(i) is variable, and is not necessarily a pre-determined constant.

Let the aggregate load on server j be

$$L ( j ) = {\sum }_{i} l ( i , j ) .$$

This presumes that the load metric is additive across services, which is true for all of the metrics described earlier in this section, and also for most other metrics. For this server, r(i,j)=f_i(L(j)). Since the function f_i( ) is non-decreasing and monotonic, the maximum aggregate load on this server that generates the same response time for this service is computed. This is given by

M(r(i,j))=max{L(j)|f(L(j))=r(i,j))}. Note that M(r(i,j))>=L(j). The maximum acceptable load that server j can handle without changing r(i,j) for any service s_i running on j is given by

$${L}_{max} ( j ) = {min}_{i} ( M ( r ( i , j ) ) ,$$

which by definition is at least L(j).

Each server sends L(j) and L_max(j) to the load-balancing system. This computation is periodically performed with period T seconds, or upon the receipt of K requests, and the load balancing system is updated accordingly. It will be understood by an artisan of ordinary skill in the art that the invention is not limited to these two options, but that other variations are possible, e.g., polling, interrupt driven, or that the date is provided by any extrinsic entity under suitable communications regime.

### B. At the Load Balancing System.

Both L(j) and L_max(j) are sent to the load-balancing system which implements algorithm ‘X’. Algorithm ‘X’ (one of the currently available load-balancing algorithms that can provide load balancing for a single service) is applied to each incoming packet request. It determines which servers are running this service and the service type for the request. Among all the servers running this service, if there exists a single server j such that the load condition L(j)<L_max(j) is satisfied, then the request is sent to server j. If there are multiple such servers satisfying this condition, any one of these servers can be selected using one of the following policies: random, least-server-id (each server has a numeric id. The least-server-id is defined as the lowest numbered id among all servers present, and refers to the server that has this id), last-server-selected, or round robin and this request is sent to the selected server.

Alternatively, if, for all servers running this service, L(j)=L_max(j), then Algorithm ‘X’ is applied to determine which server should now receive the packet.

The storage requirements for this algorithm at the balancing system are proportional to the number of servers denoted by O(m). This is also the total communication overhead of the load-balancing system with the servers.

The load balancing system can also implement QoS management in evaluating QoS policies and goals. One of the ways to evaluate the response time is by testing (e.g., ping) the response of a targeted server to see whether the QoS goals have been achieved.

In another embodiment, the response times are intrinsic to the load balancer. Under that condition, the response time of each service on a server can by itself be a load metric if this measure can be known to the load balancing system. Typically, the response times for each service on a server, r(i,j), is sent by the server to the load balancer. In this case, the load balancing algorithm simply sends a new request of service s_i to the server with the least response time for service s_i, among all the servers that run s_i. If there are multiple such servers satisfying this condition, any one of these servers can be selected. The following policies are used in the selection of a server: random, least-server-id, last-server-selected, or round robin. The generated request is sent to the selected server.

This implies that the load balancing system has to keep track of r(i,j) for all possible combinations of service s_i and server id j. The computations performed in the above embodiment are not necessary, since the response time metric is not additive. However, the storage requirements for this algorithm at the balancing system are proportional to the product of the number of services and the number of servers, O(mn). This is also the total communication overhead of the load-balancing system with the servers.

In yet another embodiment, the system incorporates a seamless server failover component. The load balancing system has the capability to detect the status of a server (failed or operational). When a failure is detected, the failed server's state and operations are moved to a backup server. In order to ensure that incoming packets are seamlessly redirected to this new server, existing balancing-tables that map flow identifiers to server id must be updated to reflect the new server's id. This task can consume a lot of time since these flow balancing tables can be very large, and can lead to requests getting lost if they arrive before the update is completed. Instead, a hitless instant update scheme ensures this re-mapping is done efficiently with no packet loss.

The load balancing system has a Flow Balancing table which specifies the target server for a particular redirected flow. It consists of two columns: a ‘flow identifier value’ and a ‘server-id’ field. As a prophylactic measure, a separate table called the Server Mapping Table consisting of two columns: a ‘virtual server id’ and a ‘physical server id’ is created. The ‘server-id’ column of the Flow Balancing table is modified to now contain a ‘virtual server id’. The Flow Balancing Table and Server Mapping Table are modified to show how the physical server id of a failed server is updated to that of the backup server.

Every request that is received by the load balancing system now involves two table lookups as opposed to the one lookup in contemporary systems. The ‘virtual server id’ corresponding to the flow identifier of the request is determined from the Flow Balancer Table, and this virtual server id is now used to look up the physical server id from the Server Mapping Table as illustrated below.

Server Mapping Table

| Virtual Server ID | Real-Server-ID |
|---|---|
| 1 | 6 |
| 2 | 3 |
| 3 | 1 |
| 4 | 5 |

When there is a server failover from primary server to backup server, the physical server id of the failed server is updated to that of the backup server in the Server Mapping Table. For example, if server ‘6’ failed, then the server farm will redirect traffic originally destined to the failed server to a replacement (alternate) server. If server ‘2’ is chosen as the replacement server, the Server Mapping Table is subsequently modified to show the virtual server id corresponding to the failed server. By performing this single update operation, which can be done automatically, all subsequent requests that referred to the failed server will now be redirected by the load balancing server to the backup server. This ensures that the load-balancing service will not be degraded during the failover process. Thus, the load balancer fails over instantaneously with all traffic destined to virtual server ‘1’ now moving to the new server. The time it takes to accomplish this switch is the time needed to modify the entry of the failed server, which can be accomplished in less than a few microseconds.

Modified Server Mapping Table

| Virtual Server ID | Real-Server-ID |
|---|---|
| 1 | 2 |
| 2 | 3 |
| 3 | 1 |
| 4 | 5 |

In other embodiments, the re-routing is done to any server that is currently known to be running, including ones that are already mapped to some virtual server id. In other words, the following is also possible:

| Virtual Server ID | Real-Server-ID |
|---|---|
| 1 | 3 |
| 2 | 3 |
| 3 | 1 |
| 4 | 5 |

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A computer readable medium for storing instructions which, when executed by a processor, perform a method for load balancing in a multiple server system supporting multiple services, the method comprising:
determining an induced aggregate load for each of said multiple services in accordance with corresponding load metrics;
determining a maximum induced aggregate load on a corresponding server adapted to generate a substantially similar Quality of Service (QoS) for each of said multiple services; and
distributing said multiple services across said multiple servers in response to said determined induced aggregate and maximum induced aggregate loads, wherein the determined QoS is substantially achieved across said servers.

2. The method of claim 1, wherein the load metrics further comprise one or more of a number of active connections, central processing unit (CPU) load, memory consumption, available memory, input/output (I/O) bandwidth consumption and network throughput.

3. The method of claim 1, wherein QoS further comprises one or more uniform response time, bit rate, delay and jitter.

4. The method of claim 1, wherein a single server performs multiple services.

5. The method of claim 1, wherein different servers host a different mix of services.

6. The method of claim 1, wherein the aggregate load for each of said multiple services is expressed by:
$$L ( j ) = {\sum }_{i = 1}^{n} l ( i , j )$$
where l=load metric; and j=a specific server.

7. The method of claim 1, wherein the maximum aggregate load on the corresponding server is expressed by:
M(r(i, j))=max {L(j)|f(L(j))=r(i, j))}

8. The method of claim 1, wherein the load balancing system determines for each incoming packet request, which of said one or more servers are running the corresponding service.

9. The method of claim 1, wherein among all the servers running the service the load balancing system forwards the request to a single server satisfying the load condition.

10. The method of claim 1, wherein when there are multiple servers satisfying the load condition, the load balancing system forwards the request to a server selected on the following policies: random, least-server-id, last-server-selected and round robin.

11. The method of claim 10, wherein when the loading is insignificant the load balancing system forwards the request to a server selected on the following: random, least-server-id, last-server-selected and round robin.

12. A multiple server system supporting multiple services, comprising:
at least one load balancing server communicatively coupled to at least one server supporting multiple services, each load balancing server adapted to distribute said multiple services wherein a QoS for each of said multiple services is substantially uniform across one or more servers supporting a corresponding service; and
one or more networked servers adapted to compute a respective induced aggregate load and a maximum induced aggregate load for each of multiple services supported by said servers.

13. The load balancing system of claim 12, wherein upon failure of a server, the load balancing system moves said server's state and operations to a backup server.

14. The load balancing system of claim 12, further comprising a Flow Balancing table adapted to redirect a flow to a server.

15. The load balancing system of claim 12, further comprising a Server Mapping table.

16. The load balancing system of claim 13, wherein upon switch-over to the backup server the physical server id of the failed server is updated to that of the backup server in the Server Mapping table.

17. The load balancing system of claim 16, wherein the best QoS further comprises the least a response time.

18. A computer readable medium for storing instructions which, when executed by a processor perform a method for load balancing in a multiple server system supporting multiple services, the method comprising:
determining the QoS for each of said multiple services running on a corresponding server; and
transmitting, a new request for service to the server with the best QoS for a corresponding service.

19. The method of claim 17, wherein the load balancing system forwards the request to a server selected on predefined policies.
